(19) United States
(12) Patent Application Publication
(10) Pub. No.: US 2019/0311828 A1
(43) Pub. Date: Oct. 10, 2019

(54) Laser Pin Welded Electrical Lamination Core and Method

(71) Applicant: Daryl Wayne Maxwell, Monroe, WI (US)

(72) Inventor: Daryl Wayne Maxwell, Monroe, WI (US)

(21) Appl. No.: 16/376,792

(22) Filed: Apr. 5, 2019

Related U.S. Application Data
(60) Provisional application No. 62/761,767, filed on Apr. 6, 2018.

(51) Int. Cl. H01F 3/02; H02K 15/02; H02K 15/095; H02K 3/52; H02K 1/24; H02K 1/14; H01F 41/02

(52) U.S. Cl. CPC H01F 3/02; H02K 15/022; H02K 15/095; H01F 41/0233; H02K 1/24; H02K 1/14; H02K 3/522

(57) ABSTRACT

Metal laminate cores can be assembled with laser pin welding through a thickness of a first laminate into a second laminate and successively laser pin welding a plurality of second laminates, ending with a third laminate to form the core stack. The laser pin welds are located within an outer perimeter of one or more of the laminates. Such laminated cores are often utilized in electrical motors, generators, transformers, lighting and other applications. The laser pin welds can be selectively provided under the control of a processor to index about the parts and/or change in intensity or even skip certain parts so as to be able to begin and end cores for some embodiments while also facilitating manual and/or automated stacking/welding embodiments and/or relative rotation of the cores.

### CLAIM OF PRIORITY

This application claims the benefit of U.S. Provisional Patent Application No. 62/761,767 filed Apr. 6, 2018 which is incorporated herein by reference in its entirety.

### FIELD OF THE INVENTION

The present invention relates to a method of manufacturing and a resulting laminated stack or core which is often utilized in various industries such as electrical motors, generators, transformers, ballasts, contactors, and/or possibly other industries or uses.

### BACKGROUND OF THE INVENTION

Laminated cores are typically made from die stamping laminations as planar parts and then initially connecting them together adjacently. There are three principal ways this has been done in the prior art. They are then often further processed such as by applying wire windings about teeth, die casting, overmolding, etc. and/or further assembled into products.

A first method of initially connecting parts together as laminates is through traditional mechanical interlocking. See FIGS. 1 and 2. Specifically, a depression (known as an interlock) is placed into, or possibly through, a stamped layer so that when an adjacent layer is pressed into it, the two layers mechanically join together. Thus, successive laminations are “locked together” to form a stack of a desired height. There are some applications where this construction can work well. However, this construction may create deformation of a part at the location of the interlock and can be extremely difficult to provide for thin materials. Additionally, the location of the interlock necessarily disrupts the surface area of the material at these connection locations to potentially adversely affect electrical performance.

A second prior art construction is the adhesive bonding of one laminate to another. This can be performed typically in one of two ways. First, the material to be die stamped can be pre-coated prior to stamping and then can cure after adjacent laminates are automatedly stacked on top of another to form a core. Second, a fixture can be provided onto which adjacent laminations can be situated (manually or automatedly), with adhesive applied and then waiting and/or heating until the adhesive cures to remove the core. These processes can significantly slow the overall production process by requiring curing in place. Not only can this process be very labor intensive, it can require a large amount of fixturing. Adhesive bonding also requires adhesive which typically increases the cost of goods, particularly when thinner and thinner materials are used for more and more laminations.

A third method used in the prior art provides initially assembling a stack and then providing a seam weld, which typically extends vertically along a core back from a bottom to a top along an outer (although sometimes an inner) perimeter of the layers of the core back in a vertical manner. This weld is located on or external to a perimeter of the individual laminates such as along an edge of the stack.

Nevertheless, a need exists to provide an improved method of joining adjacent laminated metal parts together.

Another need exists to provide an improved laminate stack or core which provides a tighter stack, possibly more consistent surface area than interlocked components, more reliable assembly, and/or can potentially be more rapid assembly than adhesively bonded layers of laminations for at least some embodiments.

### SUMMARY OF THE INVENTION

It is an object of many embodiments of the present invention to provide an improved laminated stack for use in various industries.

It is another object of many embodiments of the present invention to provide an improved method of manufacturing layers (laminations) of planar, or possibly even non-planar, parts as a stack for various applications.

Another object of many embodiments of the present invention is to provide an improved method of providing stacked laminate metal cores which are joined together internal to their internal and external perimeters preferably without significantly disrupting the electrical performance of the parts and/or core.

Accordingly, in accordance with a presently preferred embodiment of the present invention, adjacent laminate parts are preferably die stamped, then stacked. The laminate could be produced in other ways other than die stamping for other embodiments. During the stacking process, the parts can be pinned, preferably laser pin welded, to an adjacent component part. Possibly other welding techniques, such as ultrasonic or other welding techniques, may be employed as well with the teachings herein. Often, the laser pin weld has a sufficiently small surface area so as to not significantly interfere with the electro mechanical properties of the core stack, and often has a smaller surface area than an interlock utilized in a corresponding application.

In many embodiments the laser pin weld can occur intermediate to the internal and external perimeters of the planar parts, possibly without significantly disrupting the surface area of any specific part. In some embodiments, there might not be an inner perimeter. By selecting the appropriate specifications on the laser spot welder, a first part or laminate can be connected to a second adjacent part or laminate in a quick and secure manner through laser pin welding. The laser pin weld can be directed completely through the first part and at least onto, if not into, or even through, the second or successive part(s) by providing the laser pin weld in a direction which has a first vector component in a direction perpendicular to a plane of the part. As one of ordinary skill in the art will understand, the laser pin weld need not be perpendicular to the plane of the part welded (although it could be for some embodiments). Some embodiments could be welded at angles to this direction, possibly having a second vector component parallel to the plane of the part. The laser pin weld as it contacts the second part is located within a cross section of the second part, such as intermediate inner (if present) and outer perimeters of the second part. Some embodiments have the laser pin weld spaced from perimeters of the second part, and possibly the first part as well.

In some embodiments this connection may be performed in a fixture while stacking the laminates, or from an automated die stamp machine, and in still other embodiments at a stack station (manual or automated) and/or at a choke barrel in or out of a die station. Still other stacking stations may align adjacent parts for welding as taught herein. Connecting may also be performed in a separate fixture from a die stamping machine (press) such as when the laminates are automatedly stacked, or even manually stacking and connecting.

For many embodiments the process can be performed in an automated fashion to stack laminates to a desired height. The cores can be provided for various specific uses such as, but not limited to, electrical motors, generators, lighting ballasts, contactors, transformers, switches and/or other components.

### BRIEF DESCRIPTION OF THE DRAWINGS

The accompanying drawings illustrate preferred embodiments of the invention and, together with the description, serve to explain the invention. The drawings may not show elements to scale. These drawings are offered by way of illustration and not by way of limitation:

FIG. 1 is a plan view of a prior art laminate;

FIG. 2 is a cross sectional view taken along AA of FIG. 1;

FIG. 3 is a perspective view of a preferred embodiment of the present invention;

FIG. 4 is a detailed view of the portion shown in FIG. 3;

FIG. 5 is a detailed portion of the embodiments of FIGS. 3 and 4 with the punch and lasers removed;

FIG. 6 is a perspective view showing a stack created through the process shown in FIGS. 3-5;

FIG. 7 is a cross section view of a portion of the stack shown in FIG. 6; and

FIG. 8 is a perspective view of an alternative embodiment of an assembled lamination stack.

### DETAILED DESCRIPTION OF THE PREFERRED EMBODIMENTS

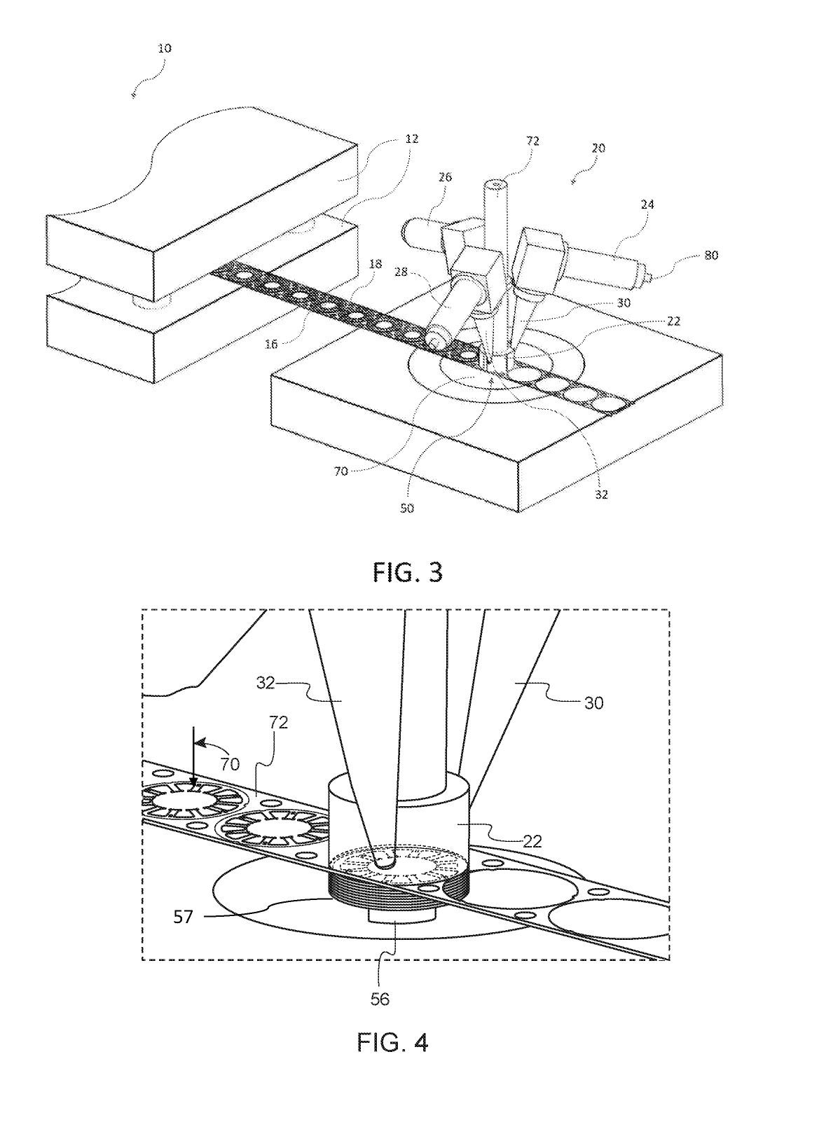

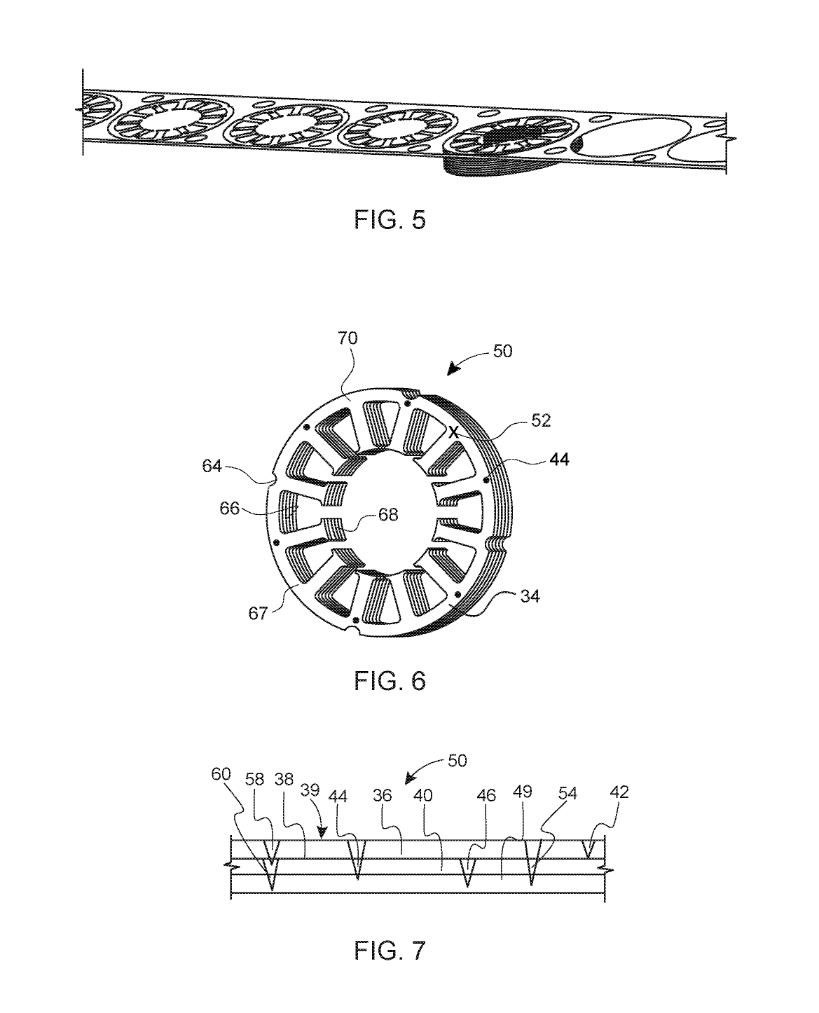

FIG. 3 shows the first present preferred embodiment of the present invention in the form of a press station 10 which may provide an initial die 12 which may define laminates or parts 16 in strip 18, possibly so that one can “carry in place” to the stacking station 20, which may be a part of the press station 10 or a separate machine and/or location. At the stacking station 20, a punch 22 or other device may remove the laminate 16 from the strip 18 if not already removed and set them one on top of another to a desired stack height. Meanwhile, while each additional part 16 of the laminate is stacked, one or more (possibly a plurality) of lasers 24,26,28 (or even more) can direct energy shown with energy beams illustrated as conical beams 30,32 (the other being obscured from view) possibly through openings or bores proceeding through the punch 22 to perform laser pin welding through an upper surface 34 of a first component part 36, through the thickness of the first part and either onto an upper surface 38 of a second lamination part 40 or into the second lamination part 40, or possibly even through the second lamination part 40. Specifically, laser pin weld 42, which could be a first laser pin weld, shows a laser pin weld extending onto the upper surface 38 of the second compound part whereas another laser pin weld 44, which could be a first laser pin weld, extends into the second lamination part as do others that are illustrated and discussed further below.

The beams 30,32 may be much smaller as may be the lasers 24,26,28 for many embodiments as compared to the figures. The items shown are not necessarily to scale in the figures. Many of the laser pin welds 42,44,46, etc. may be much smaller than illustrated for many embodiments. Lasers 24,26,28 may be pulsed for many applications to operate very quickly.

Similarly, the part below the first part 36 i.e., the second part 40 has previously been stacked and welded to a third lamination part 49 with laser pin weld 46 before the first part 36 is stacked on the second part 40. This laser pin weld 46 could be a second laser pin weld. Laser pin weld 46 can be similar in construction to laser pin weld 44, or different. The stacking process would normally be performed with a third lamination 49 having one or more second laminations 40 placed on top and joined through laser pin welding before another second laminate is placed on top of the one before. Finally, a first lamination 36 placed on top of the highest second lamination often completes the stack. The numbering of first, second, third could otherwise be a little confusing, but as one views the stack from the top, this is how the numbering has been attempted to be maintained consistently throughout this application.

One of ordinary skill in the art will notice that laser pin weld 46 has been indexed relative to laser pin weld 44 in the embodiment shown in FIG. 6 of a core or stack 50 which may have a plurality of laser pin welds 44 extending through the upper surface 34. On the second laminate part 40 the laser pin weld 46 could be located at a different location relative to the first laminate part 36 such as location X 52 illustrated in FIG. 6 or elsewhere. The applicant is currently experimenting with locating the laser pin welds in different locations as the parts are stacked. This can be done automatedly such as by rotating the stack 50 and/or alternating the use of the focal heads or lasers 24,26,28 (or more lasers, etc.) either with the punch 22, turntable 71, or separately such as relative to a stacking station 20 which could be either a manual stacking station, a stacking station as a portion of the die-stamp system 10 or a separate welding and/or stacking station. Punch 22 could be rotated, and/or possibly lasers 24,26,28, etc. could be rotated but many embodiments could rotate stack 50 and/or alternate which of lasers 24,26,28, etc. are utilized on a specific layer of the stack 50 as it is formed.

In the context of automated stacking stations 20, amazingly fast stacks 50 can be created as the laser pin welds can be performed while stacking without slowing the stacking operation in many embodiments due to the particularly quick nature of the laser pin welding process (such as less than 5 milliseconds per laser pin weld or other time). Furthermore, by indexing the positions of the parts, (stack 50), some embodiments can affectively change the position of the laser pin welds about the parts 36,40 and others such as 44. Some embodiments can also vary the intensity of the lasers 24,26,28 whether to barely contact a lower laminate such as by barely proceeding through the upper laminate 36 to barely contact upper surface 38 of the second laminate 40 or possibly extending completely through the second laminate 40 into the third laminate 49 such as is shown by laser pin weld 54.

Furthermore, unlike complicated interlock systems which would employ a back pressure system 56 or a choke 57 shown in FIG. 4 to hold while pressing adjacent laminates together, the laser pin weld could be either performed with a choke 57 or very little choke pressure holding the stack 50 from below (or otherwise) or the choke 57 could be replaced with a mere plunger and/or other structure possibly onto which the stacks rest and/or possibly assists in alignment. Punch 22 or other structure may provide the desired stack 50 shown in FIGS. 6 and 7 or others (and/or partially complete stacks 50 during the stacking process) which could be of any desired height based on the embodiment at issue.

Each of the layers 36,40,49 are typically steel or other metals. Often the parts can be as thin as 0.010 inches (or thinner). They can certainly be thicker for various other embodiments. Layers of laminates 36,40,49 etc. can be coated. Laser pin welds could be stacked such as laser pin welds 58,60 shown in FIG. 7 so as to provide either a continuous laser pin weld and/or a series of cone shaped stacked laser pin welds 58,60 one on top of another one possibly intersecting one another such as is shown in FIG. 7 or otherwise.

All of the illustrated laser pin welds 44,46,42, 54,58,60 are shown internal to the outer perimeter 64 of the core back as well as internal to an inner perimeter 66 of the core back as well as to an inner perimeter 68 (or innermost perimeter) which could include the teeth 70. In many embodiments the laser pin welds 44,46,42,54,58,60 do not contact the outer perimeter 64 or the inner perimeter 66 and/or 68.

Other embodiments (such as a cooperating rotor or other component) may have outwardly directed teeth, and/or possibly no inner perimeter about an opening depending on the embodiment of the stack 50.

As can be seen from FIGS. 3 and 4, the lasers 24,26,28 preferably direct the lasers downwardly through the upper face 34 of the uppermost part 36 with at least some portion of that laser illustrated by cones 30,32 extending to provide a first vector component extending in the direction 70 which is illustrated perpendicular to a plane 72 from which the parts 36,40,49 have been stamped and/or otherwise provided. Another second vector component may extend along plane. The first and second vector components comprise a vector which could be angled relative to direction 70 but extends through plane 72. The cross section of the parts 36,40,49 is planar, often coplanar to the plane 72 when die stamped. The lasers 24,26,28 need not be exactly perpendicular to the upper face 34, but could instead be angled to contact the upper face 34 (about 15 degrees is illustrated relative to direction 70 in FIGS. 3 and 4). Angles could be less or more for various embodiments as long as a vector exists in direction 70 (i.e. up to, but not including 90 degrees).

No one is known to direct laser energy through the upper surface 34 of a first part so that the laser pin weld contacts an upper surface 38 of an adjacent part 40 and/or extends into that part 40 or even through that part 40 such as is shown in the various embodiments shown on FIG. 7 particularly without contacting one of an inner perimeter 66 or 68 (if present) or outer perimeter 62 such as internal to a cross section 67 parallel to a plane 72 of the parts 36,40,49.

Some laser pin welds 44 may only contact a coating layer of the adjacent part 40 and not extend into metal there below. In fact, some laser pin welding techniques may be able to direct energy through a part 34 to laser pin weld to second part 40 so that just the coatings of the parts bond together.

Although FIG. 7 shows a laser pin weld 54 going at least partially through three parts 36,40,49 it should be understood by those of ordinary skill in the art that even more parts than illustrated could be connected together with a single laser pin weld.

While the blank and carry technique shown in FIGS. 3 and 4 is a particularly attractive way of transferring blanks, laminations or other parts 16 to a stacking station 20 with strip 18 which could be a part of the die machine 10 or a separate station, certainly the part 16 could be stacked, transported and/or moved with other mechanisms either with or without a blank and carry system. Magnets, conveyors, robots, air pressure, manually, ramps and/or other mechanisms may be helpful with various embodiments.

The stacking station 20 could be independent of die machine 10 and it could involve a punch 22, or not, based on the construction provided. The laser beams 30,32 need not necessarily be directed through an opening in the punch 22 which has been found to be a very attractive option for some embodiments, but instead could be independently provided and/or provided in other ways as would be understood by those of ordinary skill in the art, such as beside punch 22 or otherwise. Stack 50 may be aligned at the stacking station 20 using a variety of technology apart from the preferred embodiments described herein.

In the illustrated embodiment of FIG. 6 six laser pin welds 44 have been provided about the circumference such as in a symmetrical manner. Other embodiments need not necessarily require symmetry and certainly fewer or more than six laser pin welds 44 could be provided in or through any given layer 34. When indexing the embodiment illustrated in FIG. 6 one could rotate the stack 50 another 30 degrees by rotating turntable 70 and possibly welding laser pin welds 44 of 30 degrees radially offset to those illustrated, or any other angle or position. Rotating the punch 22 and/or lasers 24,26,28 and/or any other lasers could be a possibility for other embodiments although alternating use of which lasers 24,26,28, etc. are energized for a given layer and/or rotating the stack 50 could be likely for many embodiments. Not only could the stack 50 be rotated relative to lasers 24,26,28 stack and/or lasers 24,26 and/or 28 could be moved linearly within or for the next layer of laser pin welds 44. Processor 80 could be utilized to maintain desired position and/or elevation of layer 34. Servo controls and/or even further automation, possibly not unlike a CNC machine or other technology, could be used to move one of stack 50 and/or lasers 24,26,28 for applying laser pin welds 44. Depending on the geometry of the parts 34,40 etc. and desired placement of laser pin welds 44, the equipment and processor 80 could be provided to provide laser pin welds 44 at many, if not virtually any position along a surface of the part 34,40, etc. such as an upper and/or lower surface.

The embodiment of FIGS. 3 and 4 shows welding occurring through an opening in the die or punch 22. Other embodiment may occur outside the die or punch 22 such as a very similar arrangement as shown in FIG. 3 except that instead of providing a punch 22, a plunger 72, or other suitable device might be utilized merely to push and/or hold the blank in a desired position, possibly with a piston, back pressure device 56 or choke 57. Furthermore, there may not necessarily be a blank and carry type construction in that the part 16 could be stacked immediately upon forming. Certainly, other forming techniques could be utilized in other embodiments other than die stamping as well other stacking technology could also be employed with various embodiments.

The actual time to laser pin weld is on the order of less than five milliseconds for many embodiments so the process of welding can occur virtually simultaneously with the stacking in many embodiments. The wait time between laser pin welds may be controlled as well. Of course, the station 20 could be provided outside of a die machine 10 for various embodiments and could be even a manual stacking location as well.

In many embodiments, the lasers 24,26,28 could be located above the stack 50 as is stacked in a stacking station 20. Many embodiments will provide a stack 50 which ends up being a stator which can cooperate with a rotor but still other laminates may provide other cores and/or stacks 50 for various other uses whether that be for motors, generators, rotors, transformers, ballasts, switches, connectors and/or other uses.

One of ordinary skill in the art can see that varying the intensity of the laser beams 30,32 from the lasers 24,26,28 could be controlled or directed by a processor 80 so that as the third blank 44 is put in the stacking station 20, no welding occurs when next part 36 or second part 40 is stacked on the third part 44 then quite possibly a lesser amount of energy might be applied than would be applied through first part 36 onto or into (or even through) second part 40. One can quickly see that by varying the parameters with the processor 80, the quality of the stacks 50 may be improved and speed may be increased. Although three layers 36,40,44 shown in FIG. 7 the stacks 50 can take various thicknesses whether it be three parts as illustrated as stack 50 and or other number of parts connected together, such as ten, twenty, fifty, one hundred, etc. In the illustrated embodiment, stacking station 20 may take the form of a die or choke barrel or other structure. The processor 80, and/or other processors, may also be utilized to control other components such as the turntable 71, punch 22 and/or other components discussed herein.

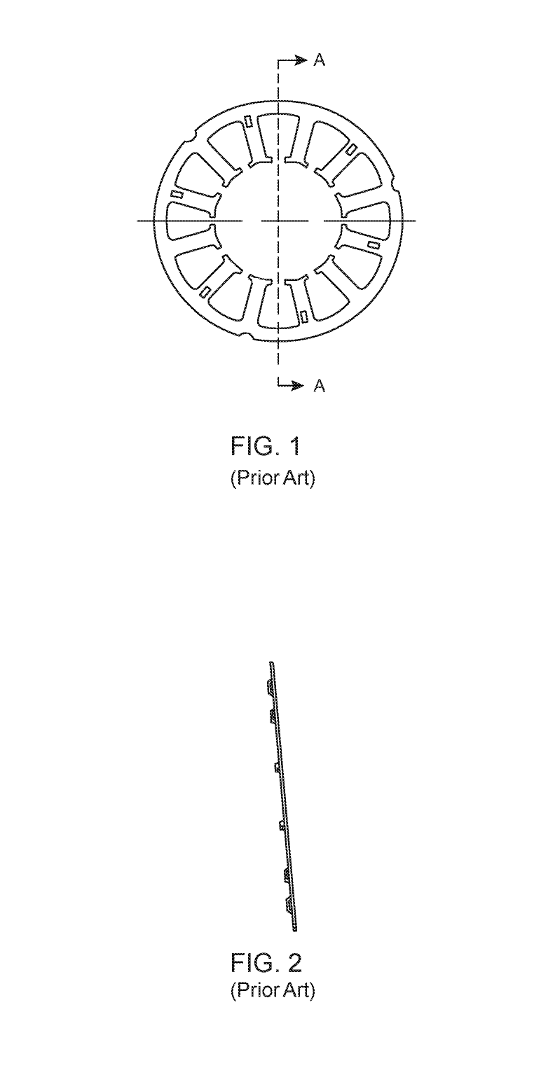

One of ordinary skill in the art can quickly see the flexibility of this technology in being able to rapidly connect adjacent laminates together to provide a stack 50 for various uses in the marketplace which by reducing problems encountered with the prior art interlocking design such as those shown in FIGS. 1 and 2 and others while also removing the time requirements and/or cost of adhesives used in other prior art constructions or issues associated with outer or inner perimeter seam welds.

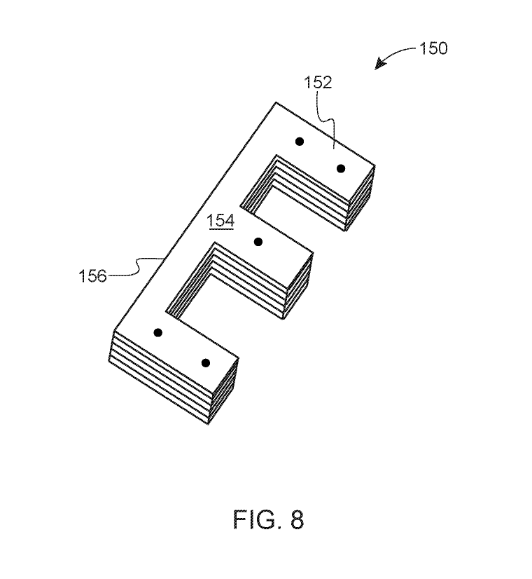

FIG. 8 shows an alternative embodiment of a stack 150. The stack has parts 152 which do not have an inner perimeter. Parts 152 could be from a transformer core or other component whether used in the electrical or other industry. Part 152 has a cross section 154 defined as an area or surface internal to an outer perimeter 156.

In many embodiments, a first laminate which ultimately ends up as the third part 49 is punched and/or otherwise provided to start the stack 50 or 150. A second laminate is then normally placed over the first laminate to form the second part 40. A plurality of second parts 40 may be stacked as second laminates. As the second laminate is placed on top of the first laminate, or another second laminate, it is normally laser pin welded as described above to the first laminate. Furthermore, a series of second laminates could be laser pin welded to each other. The first laminate may be secured when connecting the second laminate to it. As the successive second laminates are put in place and secured above the preceding laminates, one or more are often located in place and at least aligned if not secured to the preceding laminate successively, i.e., one at a time. It may also be possible to secure more than one at a time so as to provide a stack 50 or 150.

The laser pin welds 44 can be light such as proceeding all the way through one of the laminates and going onto the surface of the next layer. Laser pin welds could also be heavier and go through not only the top most part or first part 36 or even a second part 40, but also into or through more than one of the second parts 40 such as second part 40 below the first part 36. The laser pin weld can be withdrawn or not placed in the upper most part 36 so as to start a new stack 50. The specific locations of the laser pin welds 44 can be alternated and/or put at different locations within the stack 50 or 150 such as controlled by the processor 80 or otherwise. For instance, for the illustrated embodiment, the locations of laser pin welds 44 are shown on alternating teeth. Of the twelve teeth, six have laser pin welds, while the other six teeth could have laser pin welds on the next layer (obscured from view) while the illustrated location of laser pin welds 44 are weld free on the next layer. Furthermore, if only three laser pin welds 44 are placed per laminate, then it could be that the laser pin welds 44 rotate positions about the teeth successively or otherwise based on control the processor or otherwise. Even further direction of laser pin welds 44 could be controlled by processor 80.

With the blank and carry, the laminates can be pushed out of the strip and welded. Furthermore, the blanks could be loose, registered, secured or otherwise secured and/or aligned and then welded according to the various embodiments as would be obvious to one of ordinary skill in the art based on the teachings herein.

Not only can stators and rotors benefit from such technology, but it's possible also to provide hyperloop track structures such as used in transportation or otherwise, or other linear motor type constructions having laminated core construction. It may be possible that not only electrical components may benefit from a laminated type structure, but other industries may benefit as well.

It will be obvious to those skilled in the art that hyperloop and/or linear motor technology may be possible to be provided with the processor 80. Altering the alignment of successive adjacent laminations in direction 70 could be successfully varied or altered so as to accommodate a linear and/or curving track of stack 150 or other capability for still further embodiments, such as linear motors, etc.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed herein is:

1. A laminated core comprising:
a plurality of similar planar parts formed as a stack, each part having
a thickness from an upper surface to a lower surface;
an outer perimeter about the upper surface;
wherein first and second parts of the plurality of parts are laser pin welded with a first laser pin weld extending through the thickness of the first part and at least contacting an upper surface of a second part, and the first laser pin weld located internal to the outer perimeter of the second part.

2. The laminate core of claim 1 wherein the first laser pin weld reduces in diameter as it proceeds through the thickness toward the lower surface.

3. The laminate core of claim 1 further comprising a plurality of teeth radially relative to the outer perimeter, said teeth assisting in forming one of an inner perimeter and outer perimeter.

4. The laminate core of claim 1 wherein the first laser pin weld extends through the upper surface of the second part into the second part.

5. The laminate core of claim 1 further comprising a third part of the plurality of parts located below the second part and wherein the first laser pin weld extends through the first and second parts to contact at least the upper surface of the third part.

6. The laminate core of claim 1 further comprising a third part of the plurality of parts located below the second part, and a second laser pin weld, said second laser pin weld spaced apart from the first laser pin weld.

7. The laminate core of claim 6 wherein the second laser pin weld does not contact a laser pin weld extending through the first laser pin part.

8. The laminate core of claim 1 further comprising a third laser pin part, and no laser pin welds proceed through entire thickness of the third part so that the third part forms a bottommost part of the stack.

9. The laminate core of claim 1 further comprising a plurality of second parts forming the stack.

10. The laminate core of claim 1 wherein the stack forms a core for one of a switch, a stator, a rotor, a transformer, a linear motor component, a ballast, and a contactor.

11. The laminate core of claim 1 wherein the parts have an inner perimeter about an opening and the first laser pin weld is located intermediate the inner and outer perimeters of the second part.

12. A method of assembling a stack of laminated cores comprising:
a) providing similar parts each having
a thickness intermediate an upper surface and a lower surface;
a portion defining an outer perimeter about the upper surface;
b) stacking the parts, and during the stacking process, c) welding first and second parts of the plurality of parts with energy of a first laser pin weld extending completely through the thickness of the first part and at least contacting an upper surface of a second part, with the first laser pin weld located internal to the upper surface of the second part joining the first part to the second part.

13. The method of claim 12 wherein the diameter of the laser pin weld decreases as the first laser pin weld proceeds downwardly through the first laser pin weld.

14. The method of claim 12 wherein the step of welding is performed at a die stamping machine providing the parts as planar parts.

15. The method of claim 12 wherein the step of welding is performed with a laser passing through an opening in a punch to pass through the first part, and the punch punches the first part out of a strip of material.

16. The method of claim 12 wherein the step of welding is performed automatedly at a stacking station under the direction of a processor.

17. The method of claim 12 wherein the step of welding further comprises the step of providing a processor, and said processor controls at least one of placement and energy of the first laser pin weld.

18. The method of claim 12 further comprising providing a stacking station and further comprising the step of holding the first and second parts with an alignment device while welding the first part to the second part.

19. The method of claim 12 further comprising a third part, and further comprising the step of providing a second laser pin weld through the second part to at least contact the upper surface of the third part.

20. The method of claim 12 wherein the parts are stacked as removed from a blank and carry strip at a stacking station.
